(19) United States
(12) Patent Application Publication
(10) Pub. No.: US 2026/0343370 A1
(43) Pub. Date: Oct. 29, 2026

(54) METHODS, SYSTEMS, AND COMPUTER READABLE MEDIA FOR SUPPORTING TIME AND VELOCITY CHECKS FOR ROAMING SUBSCRIBERS CROSSING ACCESS NETWORKS OF DIFFERENT TYPES

(71) Applicant: Oracle International Corporation, Redwood Shores, CA (US)

(72) Inventors: John Nirmal Mohan Raj, Bangalore (IN); Karthik Denkanikota Tirumalayar, Bangalore (IN)

(21) Appl. No.: 19/193,877

(22) Filed: Apr. 29, 2025

(51) Int. Cl. H04W 36/32; H04W 60/00; H04W 64/00

(52) U.S. Cl. CPC H04W 36/324; H04W 60/00; H04W 64/006

(57) ABSTRACT

A method for supporting time and velocity checks for roaming subscribers crossing access networks of different types includes maintaining a Diameter/SBI subscriber database of roaming subscriber registration information for registrations in different access network types, receiving a signaling message relating to a roaming subscriber seeking to register or update a location of the roaming subscriber in one of the different access network types, accessing, using information in the signaling message, the Diameter/SBI subscriber database, and locating previous registration information relating to the roaming subscriber. The method further includes performing, using the previous registration information, a time and velocity check for a registration or location update requested by the signaling message and updating registration information for the roaming subscriber in the Diameter/SBI subscriber database in response to determining that the registration or location update requested by the signaling message passes the time and velocity check.

### TECHNICAL FIELD

The subject matter described herein relates to network security in hybrid communication network deployments. More particularly, the subject matter described herein relates to methods, systems, and computer readable media for supporting time and velocity checks for roaming subscribers crossing access network of different types.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is an instance of a producer NF that provides a service. A given producer NF instance may include more than one NF service instance if the producer NF instance provides multiple services. It should also be noted that multiple producer NF instances can share the same service endpoint.

NFs register with a network function repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

In 5G communication networks, the security edge protection proxy (SEPP) is the single point of ingress and egress for the network. As such, the SEPP is one place for policy enforcement in 5G networks. In 4G communication networks, the Diameter edge agent (DEA) is one place where policy enforcement can occur, but the DEA is not always the single point of ingress and egress for the network. Many communication networks are hybrid networks with equipment from different generations. Operators of such networks would like to have a common point for policy enforcement, such enforcing time and velocity checks for roaming subscribers.

Accordingly, in light of these and other difficulties, there exists a need for improved methods, systems, and computer readable media for performing time and velocity checks in hybrid communication network deployments.

### SUMMARY

A method for supporting time and velocity checks for roaming subscribers crossing access networks of different types includes maintaining a Diameter/service-based interface (SBI) subscriber database of roaming subscriber registration information for registrations in a plurality of different access network types. The method further includes receiving, at a common point of policy enforcement for the different access network types, a signaling message relating to a roaming subscriber seeking to register or update a location of the roaming subscriber in one of the different access network types. The method further includes accessing, by the common point of policy enforcement and using information in the signaling message, the Diameter/SBI subscriber database and locating previous registration information relating to the roaming subscriber. The method further includes performing, by the common point of policy enforcement and using the previous registration information, a time and velocity check for a registration or location update requested by the signaling message. The method further includes updating, by the common point of policy enforcement, registration information for the roaming subscriber in the Diameter/SBI subscriber database in response to determining that the registration or location update requested by the signaling message passes the time and velocity check.

According to another aspect of the subject matter described herein, the common point of policy enforcement comprises a combined Diameter edge agent (DEA) and security edge protection proxy (SEPP) deployment.

According to another aspect of the subject matter described herein, the combined DEA and SEPP deployment includes DEA logic for processing Diameter messages and SEPP logic for processing SBI messages.

According to another aspect of the subject matter described herein, receiving a signaling message includes receiving, by the DEA logic, a Diameter signaling message, accessing the Diameter/SBI subscriber database includes querying, by the DEA logic, the Diameter/SBI subscriber database using information obtained from the Diameter signaling message, and performing the time and velocity check includes determining, by the DEA logic, whether it is possible to travel from a location obtained from the Diameter/SBI subscriber database and a location indicated by the Diameter signaling message within a time period equal to a difference between a current timestamp and a timestamp associated with the location obtained from the Diameter/SBI subscriber database.

According to another aspect of the subject matter described herein, the method for supporting time and velocity checks for roaming subscribers crossing access networks of different types includes performing, by the DEA logic, a network security action responsive to determining that the registration or location update requested by the Diameter signaling message fails the time and velocity check.

According to another aspect of the subject matter described herein, performing the network security action includes blocking the Diameter signaling message.

According to another aspect of the subject matter described herein, receiving a signaling message includes receiving, by the SEPP logic, an SBI signaling message, accessing the Diameter/SBI subscriber database includes querying, by the SEPP logic, the Diameter/SBI subscriber database using information obtained from the SBI signaling message, and performing the time and velocity check includes determining, by the SEPP logic, whether it is possible to travel from a location obtained from the Diameter/SBI subscriber database and a location indicated by the SBI signaling message within a time period equal to a difference between a current timestamp and a timestamp associated with the location obtained from the Diameter/SBI subscriber database.

According to another aspect of the subject matter described herein, the method for supporting time and velocity checks for roaming subscriber crossing access networks of different types includes performing, by the SEPP logic, a network security action responsive to determining that the registration or location update requested by the SBI signaling message fails the time and velocity check.

According to another aspect of the subject matter described herein, performing the network security action includes blocking the SBI signaling message.

According to another aspect of the subject matter described herein, receiving the signaling message includes receiving the signaling message at an ingress gateway, and the method for supporting time and velocity checks for roaming subscribers crossing access networks of different types includes determining, by the ingress gateway, whether the signaling message is a Diameter signaling message or an SBI signaling message, forwarding, by the ingress gateway and responsive to determining that the signaling message is a Diameter signaling message, the Diameter signaling message to the DEA logic, and forwarding, by the ingress gateway and responsive to determining that the signaling message is an SBI signaling message, the SBI signaling message to the SEPP logic.

According to another aspect of the subject matter described herein, a system for supporting time and velocity checks for roaming subscribers crossing access networks of different types is provided The system includes at least one processor and a memory. The system further includes a Diameter/service-based interface (SBI) subscriber database for storing roaming subscriber registration information for registrations in a plurality of different access network types. The system further includes a common point of policy enforcement for the different access network types, implemented using the at least one processor and configured to: receive a signaling message relating to a roaming subscriber seeking to register or update a location of the roaming subscriber in one of the different access network types; access, using information in the signaling message, the Diameter/SBI subscriber database; locate previous registration information relating to the roaming subscriber; perform, using the previous registration information, a time and velocity check for a registration or location update requested by the signaling message; and update registration information for the roaming subscriber in the Diameter/SBI subscriber database in response to determining that the registration or location update requested by the signaling message passes the time and velocity check.

According to another aspect of the subject matter described herein, the signaling message comprises a Diameter signaling message and the DEA logic is configured to access the Diameter/SBI subscriber database by querying the Diameter/SBI subscriber database using information obtained from the Diameter signaling message, and perform the time and velocity check by determining whether it is possible to travel from a location obtained from the Diameter/SBI subscriber database and a location indicated by the Diameter signaling message within a time period equal to a difference between a current timestamp and a timestamp associated with the location obtained from the Diameter/SBI subscriber database.

According to another aspect of the subject matter described herein, the DEA logic is configured to perform a network security action responsive to determining that the registration or location update requested by the Diameter signaling message fails the time and velocity check.

According to another aspect of the subject matter described herein, the network security action includes blocking the Diameter signaling message.

According to another aspect of the subject matter described herein, the signaling message comprises an SBI signaling message and the SEPP logic is configured to access the Diameter/SBI subscriber database by querying the Diameter/SBI subscriber database using information obtained from the SBI signaling message and perform the time and velocity check by determining whether it is possible to travel from a location obtained from the Diameter/SBI subscriber database and a location indicated by the SBI signaling message within a time period equal to a difference between a current timestamp and a timestamp associated with the location obtained from the Diameter/SBI subscriber database.

According to another aspect of the subject matter described herein, the SEPP logic is configured to perform a network security action responsive to determining that the registration or location update requested by the SBI signaling message fails the time and velocity check.

According to another aspect of the subject matter described herein, the network security action includes blocking the SBI signaling message.

According to another aspect of the subject matter described herein, a non-transitory computer readable medium having stored thereon executable instructions that when executed by a processor of a computer control the computer to perform steps is provided. The steps include maintaining a Diameter/service-based interface (SBI) subscriber database of roaming subscriber registration information for registrations in a plurality of different access network types. The steps further include receiving, at a common point of policy enforcement for the different access network types, a signaling message relating to a roaming subscriber seeking to register or update a location of the roaming subscriber in one of the different access network types. The steps further include accessing, by the common point of policy enforcement and using information in the signaling message, the Diameter/SBI subscriber database and locating previous registration information relating to the roaming subscriber. The steps further include performing, by the common point of policy enforcement and using the previous registration information, a time and velocity check for a registration or location update requested by the signaling message. The steps further include updating, by the common point of policy enforcement, registration information for the roaming subscriber in the Diameter/SBI subscriber database in response to determining that the registration or location update requested by the signaling message passes the time and velocity check.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1A is a network diagram illustrating an exemplary 5G system network architecture;

FIG. 1B is a network diagram illustrating an exemplary system network architecture and mappings of 4G network nodes to 5G network functions;

FIG. 2 is a diagram of a high-level architecture of a cloud deployment of a Diameter edge agent (DEA) and the use of the DEA to perform an authentication and velocity check for a Diameter message relating to a subscriber;

FIG. 3 is a diagram of a high-level architecture of a SEPP and the use of the SEPP to perform an authentication and velocity check for a service-based interface (SBI) message relating to a subscriber;

FIG. 4 is a block diagram of a combined SEPP and DEA deployment for supporting time and velocity checks for roaming subscribers crossing access networks of different types;

FIG. 5A is a message flow diagram illustrating exemplary messages exchange in supporting time and velocity check for roaming subscriber crossing access networks of different types in which the initial update location transaction originates from the 4G network;

FIG. 5B is a message flow diagram illustrating exemplary messages exchange in supporting time and velocity check for roaming subscriber crossing access networks of different types in which the initial authentication request transaction originates from the 5G network; and

FIG. 6 is a flow chart illustrating an exemplary process for supporting time and velocity checks for roaming subscribers crossing access network of different types.

### DETAILED DESCRIPTION

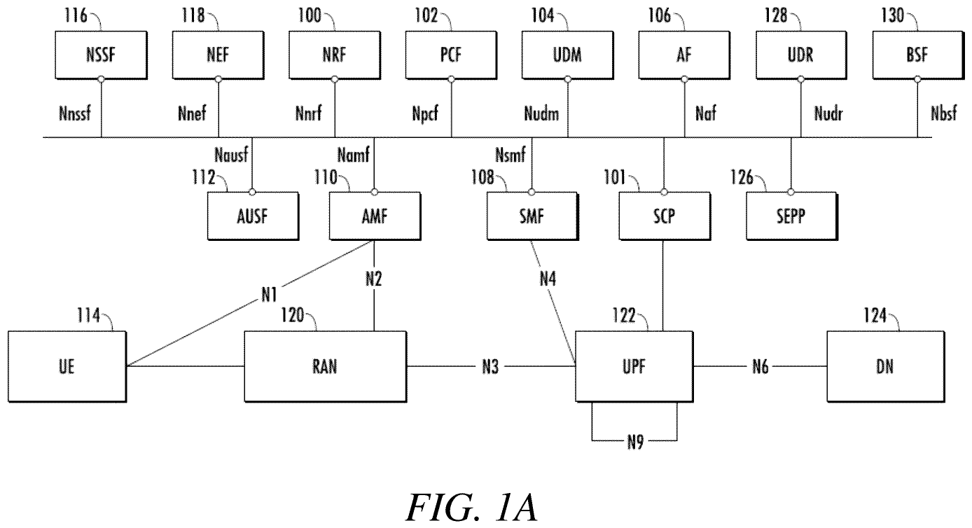

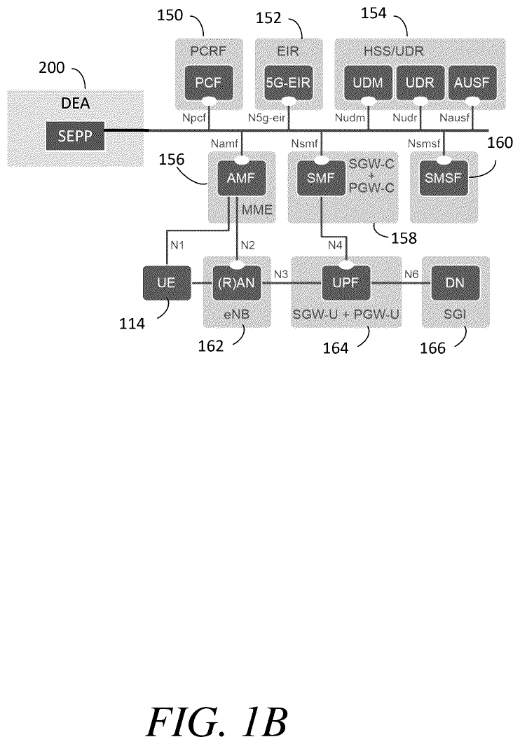

FIG. 1A is a block diagram illustrating an exemplary 5G system network architecture. The architecture in FIG. 1A includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1A, any of the network functions can be consumer NFs, producer NFs, or both, depending on whether they are requesting, providing, or requesting and providing services. In the illustrated example, the NFs include a PCF 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

SEPP 126 filters incoming traffic from another PLMN and performs topology hiding for traffic exiting the home PLMN. SEPP 126 may communicate with an SEPP in a foreign PLMN which manages security for the foreign PLMN. Thus, traffic between NFs in different PLMNs may traverse two SEPP functions, one for the home PLMN and the other for the foreign PLMN. A UDR 128 stores subscription data for UEs. A binding support function (BSF) 130 manages bindings between PDU sessions and PCFs.

FIG. 1B is a network diagram illustrating an exemplary system network architecture and mappings of 4G network nodes to 5G network functions. Referring to FIG. 1B, a policy and charging rules function (PCRF) 150 performs policy related functions for the 4G network similar to the PCF of the 5G network. An equipment identity register (EIR) 152 stores identifying information for mobile equipment, such as UE 114. A home some subscriber server (HSS) 154 stores subscriber-related information and performs functions similar to the UDM, UDR, and AUSF in the 5G network. A mobility management entity (MME) 156 performs call setup and other operations similar to the AMF in the 5G network. Serving gateway control plane (SGW-c) and packet gateway PGW control plane (PGW-c) 158 performs control plane functions associated with session management, similar to the SMF in the 5G network. A short message service function (SMSF) performs operations relating to delivery of SMS messages to UEs. Evolved node B (eNB) 162 performs radio access functions, such as interacting with UE 114 over the air interface, similar to the RAN in the 5G network. SGW user plane (SGW-U) and PGW user plane (PGW-U) 164 perform user plane functions relating to sessions with UEs, similar to the UPF in the 5G network. SGI 166 acts as the interface through which user data exits the 4G network to reach external networks, enabling internet access, VolP, and other IP-based services, similar to the DN in the 5G network. A Diameter edge agent (DEA) 200 performs screening and routing of Diameter messages, similar to the way that the SEPP routes and screens SBI messages in the 5G network.

As stated above, it would be desirable to provide a single point of policy enforcement in hybrid networks for supporting time and velocity checks for signaling messages relating to roaming subscribers. There is a need for operators to adhere to Global System for Mobile communications Alliance (GSMA) security firewalling procedures, such as those described in GSMA FS.19 and FS.36. One challenge is that these specifications individually handle different telecom technologies (pre- 5G and 5G). Operators, however, are going to be supporting heterogeneous networks for quite a long time. This poses a challenge of trying to adhere to these firewalling rules on a common platform In pre-5G networks, there were no explicit nodes defined to support a single point of egress or ingress into an operator's network. A Diameter edge agent (DEA) was assumed to be such a node; however, this was also left to interpretation. In 5G networks, the SEPP is defined as the sole proxy to be deployed at the edge of the network and thus functions as a policy enforcer for all traffic ingressing or egressing the network. Operators seldom would have a pure 5G or pure 4G network, thereby facing challenges to enforce the firewalling rules at two different points-one for 4G signaling and another for 5G signaling.

Problems facing network operators include a 4G roaming subscriber having rules governing types of access and restrictions about routing which may not be replicated when the subscriber roams into a 5G network. A velocity check may be performed during 4G registration procedures. However, the velocity check must be re-executed using a set of 5G rules when the subscriber moves to a 5G service area.

There are a variety of solutions that could be implemented for the above-referenced problems. One possible solution could be harmonization of platforms for both 4G and 5G. However, this solution could be too cumbersome and operationally challenging. Another solution could be to integrate 4G and 5G firewall rules in a common platform. This solution again has challenges of defining a new interface on an older platform or having a new platform understand an older interface.

The solution described herein includes a common data store that can be shared across both the 4G and 5G nodes, which is beneficial to both 4G monolithic architectures and 5G cloud-based deployments without having to change existing functionality of either network for operators. The solution can include leveraging of the cloud native deployment of a Diameter routing agent (DRA). A DRA is a Diameter node that routes Diameter signaling messages. A DRA deployed at the edge of a network is referred to as a DEA. The subject matter described herein is not limited to use with a cloud native DEA, as the functionality described herein will work with on-premises DEA deployments as well.

The subject matter described herein involves enabling of stateful counter measures on both the DEA and the SEPP. The subject matter described herein also includes having the DEA and SEPP in the same architecture mode or model, which, in one example includes a connection layer implemented by a common ingress and egress gateways capable of recognizing and forwarding Diameter and service-based interface messages, a business layer implemented by DEA logic for the DEA and SEPP logic for the SEPP, and a data layer implemented by a common subscriber database, including information for time and velocity check for subscribers crossing different access network types.

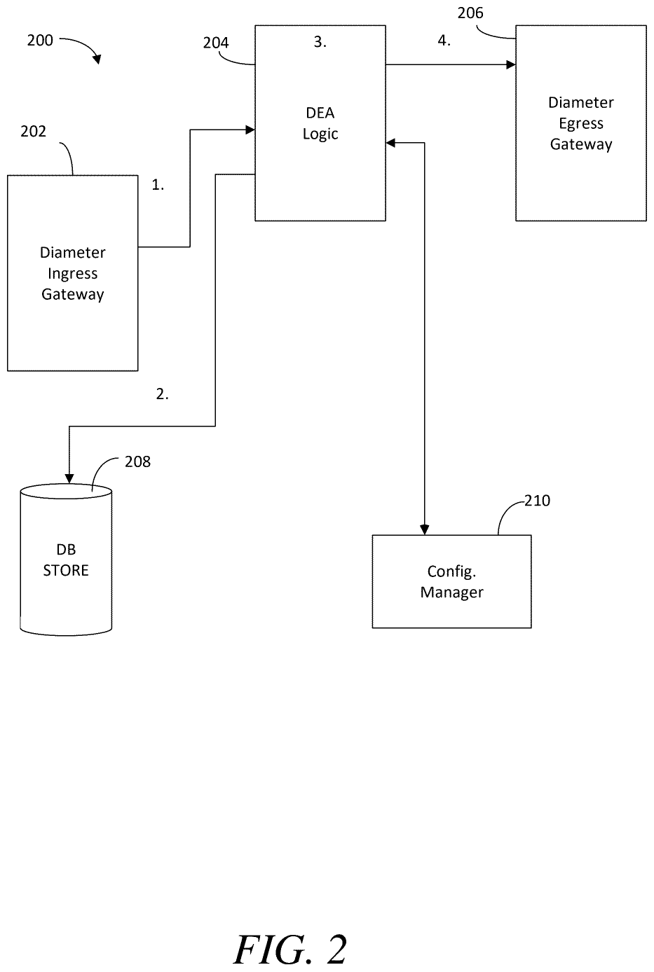

FIG. 2 is a diagram of a high-level architecture of a cloud deployment of a DEA and the use of the DEA to perform an authentication and velocity check for a Diameter message relating to a subscriber. Referring to FIG. 2, a DEA 200 includes a Diameter ingress gateway 202, DEA logic 204, Diameter egress gateway 206, a database 208, and a configuration manger 210. Diameter ingress gateway 202 is configured to receive Diameter messages and forward the Diameter messages to DEA logic 204. DEA logic 204 analyzes messages received from Diameter ingress gateway 202 using data stored in database 208 and forwards messages that pass Diameter level screening to Diameter egress gateway 206. Diameter egress gateway 206 forwards Diameter messages to other Diameter nodes.

Referring to the numbered steps in FIG. 2, in step 1, Diameter ingress gateway 202 receives a Diameter message and forwards the message to DEA logic 204. In step 2, DEA logic 204 retrieves subscriber information from database 208. In step 3, DEA logic 204 performs a subscriber authentication and velocity check for the Diameter message. In step 4, if the subscriber authentication and velocity check passes, DEA logic 204 forwards the Diameter message to Diameter egress gateway 206, which forwards the Diameter message to the subscriber's home network.

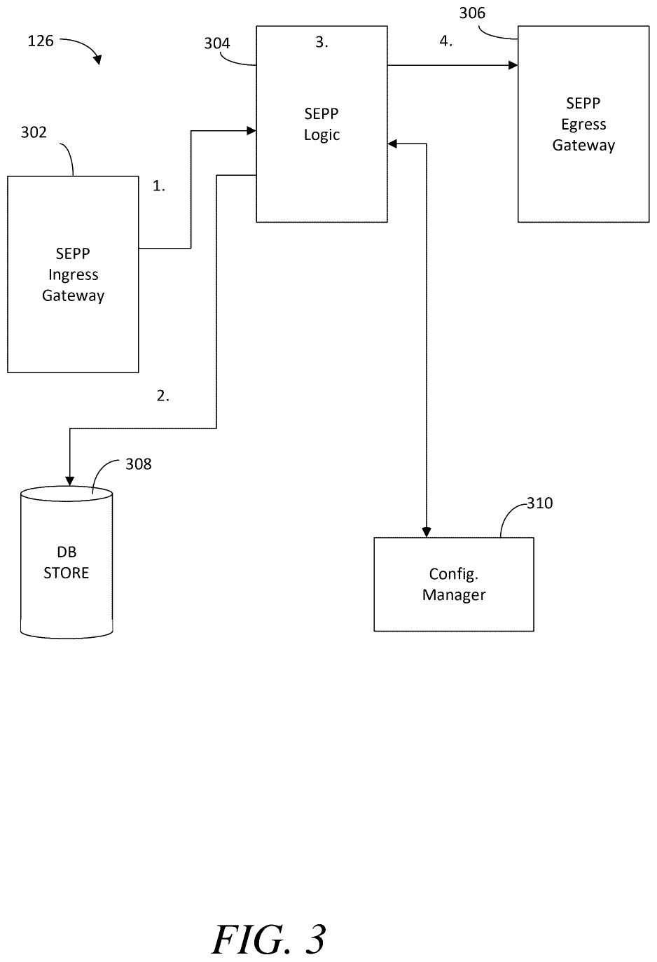

FIG. 3 is a diagram of a high-level architecture of a SEPP and the use of the SEPP to perform an authentication and velocity check for an SBI message relating to a subscriber. Referring to FIG. 3, a SEPP 126 includes a SEPP ingress gateway 302, SEPP logic 304, SEPP egress gateway 306, a database 308, and a configuration manger 310. SEPP ingress gateway 302 is configured to receive SBI messages and forward the SBI messages to SEPP logic 304. SEPP logic 304 is configured to analyze messages received from SEPP ingress gateway 302 using data stored in database 308 and forwards messages that pass SBI level screening to SEPP egress gateway 306. SEPP egress gateway 306 forwards SBI messages to other network functions.

Referring to the numbered steps in FIG. 3, in step 1, SEPP ingress gateway 302 receives an SBI message and forwards the message to SEPP logic 304. In step 2, SEPP logic 304 retrieves subscriber information from database 308. In step 3, SEPP logic 304 performs a subscriber authentication and velocity check for the SBI message. In step 4, if the subscriber authentication and velocity check passes, SEPP logic 304 forwards the SBI message to SEPP egress gateway 306 which forwards the SBI message to the subscriber's home network.

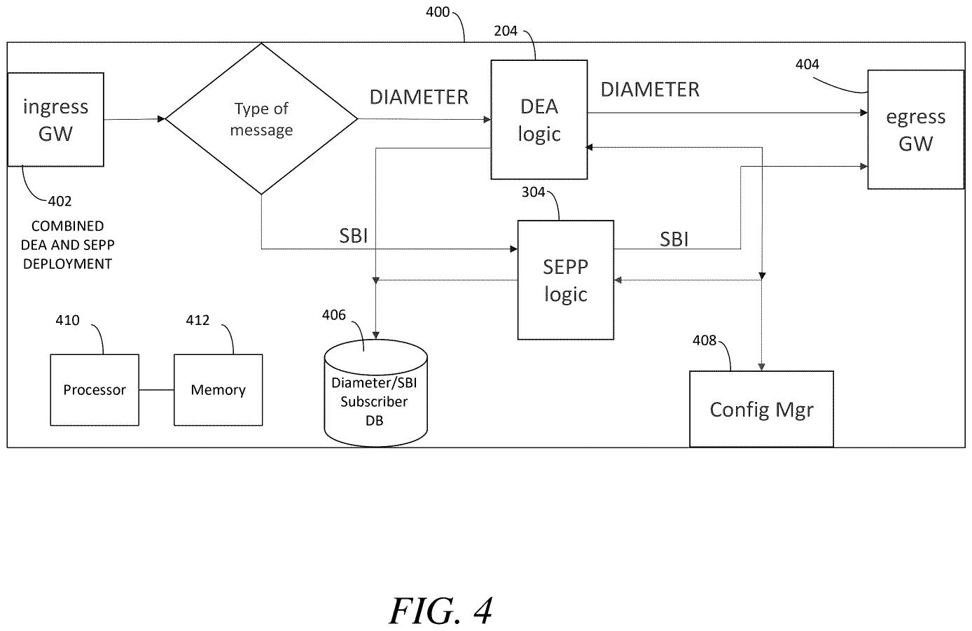

FIG. 4 is a diagram illustrating an example of a combined DEA and SEPP deployment for performing time and velocity checks using a common subscriber database. Referring to FIG. 4, combined DEA and SEPP deployment 400 forms a common point for policy enforcement for subscribers crossing access networks of different types. Combined DEA and SEPP deployment 400 includes a Diameter/SBI ingress gateway 402, DEA logic 204, SEPP logic 304, a Diameter/SBI egress gateway 404, a Diameter/SBI subscriber database 406, a configuration manager 408, at least one processor 410, and memory 412. Diameter/SBI ingress gateway 402 receives Diameter and SBI messages, including messages relating to roaming subscribers, and determines the message type of each received message. If Diameter/SBI ingress gateway 402 determines that a received message is a Diameter message, Diameter/SBI ingress gateway 402 forwards the message to DEA logic 204. If Diameter/SBI ingress gateway 402 determines that a received message is an SBI message, Diameter/SBI ingress gateway 402 forwards the message to SEPP logic 304.

DEA logic 204 or SEPP logic 304 accesses Diameter/SBI subscriber database 406 to perform an authentication and velocity check for a received Diameter or SBI message. Performing a time and velocity check may include determining whether Diameter/SBI subscriber database 406 has a record corresponding to an active registration for the subscriber, and, if Diameter/SBI subscriber database has a record corresponding to an active registration for the subscriber, reading, from the record the location of the most recent registration for a mobile subscriber and a timestamp associated with the registration. If Diameter/SBI subscriber database 406 does not include a record corresponding to an active registration for the mobile subscriber, DEA logic 204 may query HSS 154 in the subscriber's home network to obtain the most recent registration location and timestamp of the subscriber. Similarly, if the received message is an SBI message, SEPP logic 304 may query the UDR to obtain the most recent registration location and time for the subscriber. For the case where DEA logic 204 or SEPP logic 304 most recent registration and time from the HSS or the UDR, DEA logic 204 or SEPP logic 304 may create a registration record for the mobile subscriber in Diameter/SBI subscriber database 406. Thereafter, DEA logic 204 or SEPP logic 304 may maintain the registration record in Diameter/SBI subscriber database 406 and use the record to perform time and velocity checks for the mobile subscriber.

To perform the time and velocity check, DEA logic 204 or SEPP logic 304 may read a new registration location from the received Diameter or SBI message, read the timestamp associated with the new registration location and determine whether the distance between the location of the current registration and the location of the new registration is reasonable in light of the time difference. For example, if the current registration is in southeast Asia, the proposed new registration is in the United Kingdom, and the time difference is one hour, DEA logic 204 or SEPP logic 304 may determine that the proposed new registration is not reasonable because the mobile device could not have traveled the distance from Southeast Asia to the United Kingdom in one hour. In this case, DEA logic 204 or SEPP logic 304 determines that the message fails the time and velocity check and may perform a network security action, such as blocking the received message.

If the message passes the time and velocity check, DEA logic 204 or SEPP logic 304 forwards the message to Diameter/SBI egress gateway 404, which forwards the message to a Diameter node or network function in the subscriber's home network.

As stated above, if an active registration record for a mobile subscriber is not present in Diameter/SBI subscriber database 406, DEA logic 204 may conduct time and velocity checks and authentication checks on Diameter messages by contacting HSS 154 to retrieve the last known registration information of the subscriber and thereafter storing the information locally in Diameter/SBI subscriber database 406. If an active registration record for a mobile subscriber is not present in Diameter/SBI subscriber database 406, SEPP logic 304 may conduct time and velocity checks and authentication checks on SBI messages by contacting UDR 128 (defined by 3GPP TS 29.504 and TS 29.505) to retrieve subscriber information for the checks and may thereafter store the retrieved information locally in Diameter/SBI subscriber database 406. In addition, SEPP logic 304 may update the registration record in Diameter/SBI subscriber database 406 when a 5G access request arrives for the subscriber. DEA logic 204 may update the record when a subscriber moves from the 5G network to a 4G network.

The following message types are examples of messages relating to roaming subscribers and used by SEPP logic 304 and DEA logic 204 to update the table in subscriber database 406. In Diameter, the S6a authentication information request (AIR) message and S6a update location request (ULR) messages contain one or more attributes that indicate the subscriber's current location, and hence DEA logic 204 retrieves the subscriber information from HSS 154 using S6a response interface to check the velocity of the subscriber. In SBI messages, the SEPP may use the UE AUSF_Authentication procedure to identify the present location and the last authentication status stored in the 5G UDR to conduct the velocity checks. Both the DEA logic 204 and SEPP logic 304 will update the locally stored record for the mobile subscriber to enable either DEA logic 204 or SEPP logic 304 to infer latest information of the subscriber, rather than triggering queries to either HSS or 5G UDR.

The following information may be stored in the record for the mobile subscriber in Diameter/SBI subscriber database 406 maintained and updated by DEA logic 204 and SEPP logic 304:
subscriber identity;
last known location;
authentication status;
authenticated network;
registration status;
timestamp of last update; and
updated entity.

DEA logic 204 or SEPP logic 304 may retrieve subscriber identity from an ingress message. DEA logic 204 or SEPP logic 304 may obtain the last known location initially from the HSS or UDR and, once a record is created in local database 406, from local database 406. DEA logic 204 or SEPP logic 304 may obtain authentication status from either S6a-AIA or success of Nausf_UEAuthentication_Authenticate response. DEA logic 204 or SEPP logic 304 may obtain the authenticated network from information in either S6a-ULA, S6a-AIA or response of UE_authentication. DEA logic 204 or SEPP logic 304 may obtain registration status, timestamp of last update, and updated entity from local database 406, from DEA logic 204, or SEPP logic 304.

Configuration manager 408 allows the operator to configure policies, such as time and velocity check parameters, used by combined DEA and SEPP deployment 400. Ingress gateway 402, DEA logic 204, SEPP logic 304, egress gateway 404, and configuration manager 408 may be implemented using computer-executable instructions stored in memory 412 and executed by processor 410.

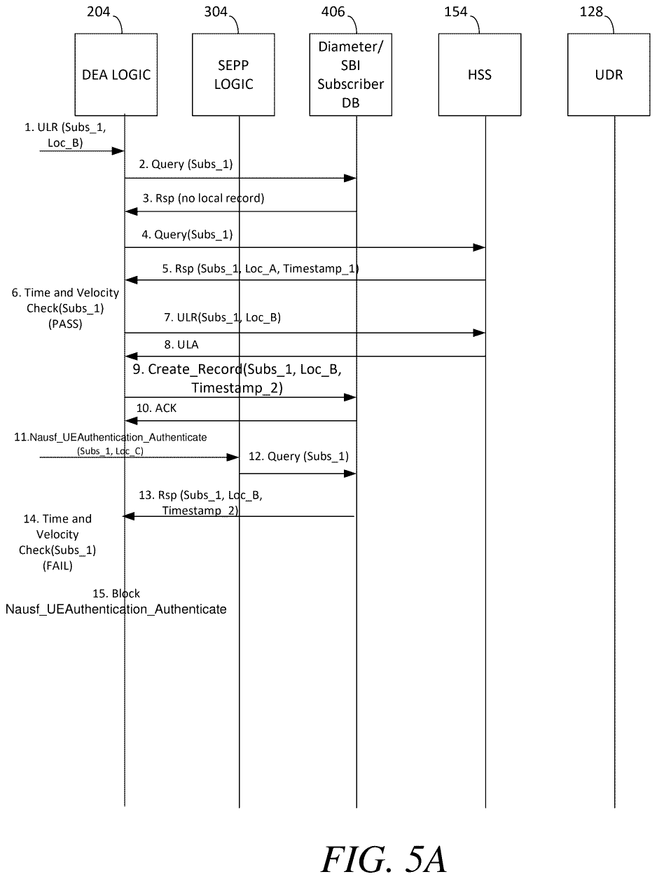

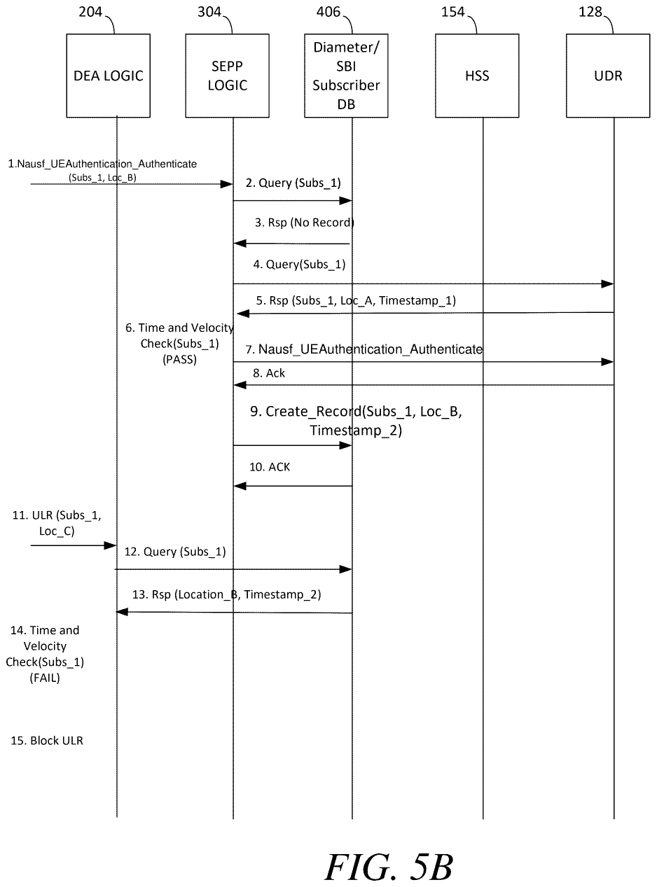

FIG. 5A is a message flow diagram illustrating exemplary messages exchange in supporting time and velocity check for roaming subscriber crossing access networks of different types in which the initial update location transaction originates from the 4G network. Referring to FIG. 5A, in step 1, DEA logic 204 receives a Diameter update location request specifying location_B for subscriber_1. In step 2, DEA logic 204 queries Diameter/SBI subscriber database 406 to determine whether an active registration record for subscriber_1 is present in Diameter/SBI database 406. In step 3, Diameter/SBI subscriber database 406 responds indicating that there is no local registration record for subscriber_1. Accordingly, in step 4, DEA logic 204 queries HSS 154 to obtain location information for subscriber_1. In step 5, HSS 154 responds indicating that subscriber_1 was last registered at location_A at timestamp_1. In step 6, DEA logic 204 performs a time and velocity check for the location indicated in the update location request message. Performing the time and velocity check may include determining whether it is possible to travel from location_A to location_B in the time equal to the difference between the current time and timestamp_1. If it is possible to travel the distance within the time period, DEA logic 204 determines that the time and velocity check passes. If it is not possible to travel the distance within the time period, DEA logic 204 may block the update location request. In this example, DEA logic 204 determines that the distance is reasonable given the time difference, and the update location request passes the time and velocity check. In step 7, DEA logic 204 forwards the update location request to HSS 154. In step 8, HSS 154 responds with an update location acknowledgement message. In step 9, DEA logic 204 creates a registration record in Diameter/SBI subscriber database 406 with location_B and timestamp_2. In step 10, Diameter/SBI subscriber database 406 acknowledges the creation of the record.

In step 11 SEPP logic 304 receives an Nausf UEAuthentication_Authenticate request message for subscriber_1 indicating location_C. In step 12, SEPP logic 304 queries Diameter/SBI subscriber database 406 to determine the last registered location of subscriber_1. In step 13, Diameter/SBI subscriber database 406 responds indicating that subscriber_1 was last registered at location B at timestamp_2. In step 14, SEPP logic 304 performs a time and velocity check for the location indicated in the Nausf_UEAuthentication_Authenticate request by determining whether it is possible to travel between location C and location B in the time period represented by the difference between the current time and timestamp_2. In this example, SEPP logic 304 determines that it is not possible to travel the distance within the time period. Accordingly, the Nausf_UEAuthentication_Authenticate request message fails the time and velocity check, and, in step 15, SEPP logic 304 blocks the Nausf_UEAuthentication_Authenticate request message.

FIG. 5B is a message flow diagram illustrating exemplary messages exchange in supporting time and velocity check for roaming subscriber crossing access networks of different types in which the initial authentication request transaction originates from the 5G network. Referring to FIG. 5B, in step 1, SEPP logic 304 receives an Nausf_UEAuthentication_Authenticate request specifying location_B for subscriber_1. In step 2, SEPP logic 304 queries Diameter/SBI subscriber database 406 to determine whether an active registration record for subscriber_1 is present in Diameter/SBI database 406. In step 3, Diameter/SBI subscriber database 406 responds indicating that there is no local registration record for subscriber 1. Accordingly, in step 4, SEPP logic 304 queries UDR 128 to obtain location information for subscriber_1. In step 5, UDR 128 responds indicating that subscriber_1 was last registered at location_A at timestamp_1. In step 6, SEPP logic 304 performs a time and velocity check for the location indicated in the Nausf_UEAuthentication_Authenticate request message. Performing the time and velocity check may include determining whether it is possible to travel from location_A to location_B in the time equal to the difference between the current time and timestamp_1. If it is possible to travel the distance within the time period, SEPP logic 304 determines that the time and velocity check passes. If it is not possible to travel the distance within the time period, SEPP logic 304 may block the Nausf_UEAuthentication_Authenticate request. In this example, SEPP logic 304 determines that the distance is reasonable given the time difference, and the Nausf_UEAuthentication_Authenticate request passes the time and velocity check. In step 7, SEPP logic 304 forwards the Nausf_UEAuthentication_Authenticate request to UDR 128. In step 8, UDR 128 responds with an acknowledgement message. In step 9, UDR logic 304 creates a registration record in Diameter/SBI subscriber database 406 with location_B and timestamp_2. In step 10, Diameter/SBI subscriber database 406 acknowledges the creation of the record.

In step 11, DEA logic 204 receives an update location request message for subscriber_1 indicating location_C. In step 12, DEA logic 204 queries Diameter/SBI subscriber database 406 to determine the last registered location of subscriber_1. In step 13, Diameter/SBI subscriber database 406 responds indicating that subscriber_1 was last registered at location B at timestamp_2. In step 14, DEA logic 204 performs a time and velocity check for the location indicated in the update location request by determining whether it is possible to travel between location C and location B in the time period represented by the difference between the current time and timestamp_2. In this example, DEA logic 204 determines that it is not possible to travel the distance within the time period. Accordingly, the update location request message fails the time and velocity check, and, in step 15, DEA logic 204 blocks the update location request message.

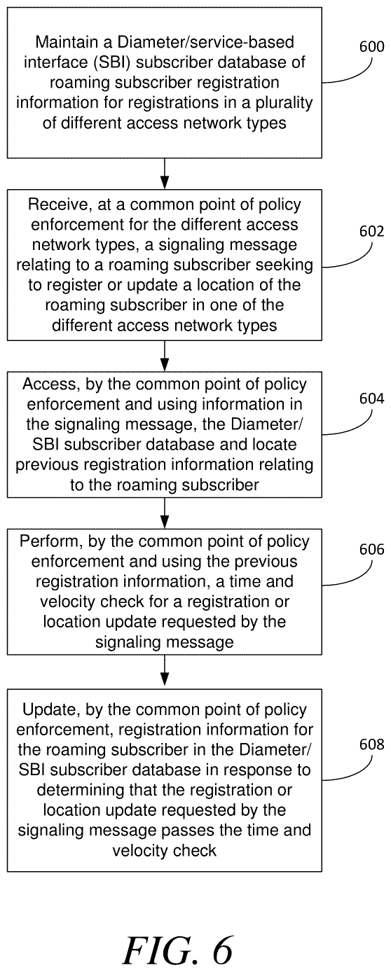

FIG. 6 is a flow chart illustrating an exemplary process for supporting time and velocity checks for roaming subscribers crossing access network of different types. Referring to FIG. 6, in step 600, the process includes maintaining a Diameter/service-based interface (SBI) subscriber database of roaming subscriber registration information for registrations in a plurality of different access network types. For example, a combined DEA and SEPP deployment may maintain a common database, such as database 406 that includes registration location information and associated timestamps for mobile subscribers.

In step 602, the process further includes receiving, at a common point of policy enforcement for the different access network types, a signaling message relating to a roaming subscriber seeking to register or update a location of the roaming subscriber in one of the different access network types. For example, a combined DEA and SEPP deployment may receive a Diameter signaling message or an SBI signaling message requesting to register or update the location of a mobile subscriber.

In step 604, the process further includes accessing, by the common point of policy enforcement and using information in the signaling message, the Diameter/SBI subscriber database and locating previous registration information relating to the roaming subscriber. For example, DEA logic or SEPP logic associated with a combined DEA and SEPP deployment may read a subscriber identifier from the received signaling message and use the subscriber identifier to perform a lookup in database 406 and obtain a previous registration location and associated timestamp for the mobile subscriber.

In step 606, the process further includes performing, by the common point of policy enforcement and using the previous registration information, a time and velocity check for a registration or location update requested by the signaling message. For example, the DEA logic or the SEPP logic associated with the combined DEA and SEPP deployment may determine whether it is possible for the mobile subscriber to travel from the registration location obtained from the local database to the location specified by the signaling message within the time period defined by the timestamp obtained from the local database and the current time. If it is possible for the mobile subscriber to travel the distance within the time period, the registration or location update passes the time and velocity check. If it is not possible for the mobile subscriber to travel the distance within the time period, the registration or location update fails the time and velocity check.

In step 608, the process further includes updating, by the common point of policy enforcement, registration information for the roaming subscriber in the Diameter/SBI subscriber database in response to determining that the registration or location update requested by the signaling message passes the time and velocity check. For example, the DEA logic or the SEPP logic associated with a combined DEA and SEPP deployment may update the record in the local database to include the new registration location and timestamp in response to a successful time and velocity check. The DEA or SEPP logic may also forward the received signaling message to its intended destination. If the DEA logic or the SEPP logic determines that the registration or location update proposed in the signaling message fails the time and velocity check, the DEA logic or the SEPP logic may perform a network security action, such as blocking the signaling message.

Exemplary advantages of the subject matter described herein include reducing the number of queries for subscriber sensitive data by the combined DEA and SEPP deployment. Using a local database for subscriber registration information enables faster retrieval and processing of the information when compared to retrieving the data from an HSS or a UDR.

Appropriate underlying security checks can be combined to ensure tightening of security firewalling. For example, the SEPP logic can recheck that the ingress message arrived from a known Diameter entity by cross validating the information in the transport layer security (TLS) certificate. The combined DEA and SEPP deployment also provides a single point of rule configuration network operators. In addition, simpler rules can be configured at the combined DEA and SEPP deployment. For example, a network operator may define a single rule for 4G and 5G networks to check that at least 8 hours have lapsed when a subscriber moves from Southeast Asia to Europe, rather than different kinds of rules for 4G and 5G for the same use case. In addition, the same PLMN-ID screening rules can be used for 4G and 5G networks. The combined DEA and SEPP deployment can leverage rules between 4G and 5G firewalls.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.2.0 (2025 March)
2. 3^{rd} Generation Partnership Project; Technical Specification Group Core Network and Terminals; 5G System; Location Management Services; Stage 3 (Release 19) 3GPP TS 29.572 V19.2.0 (2025 March)
3. 3^{rd} Generation Partnership Project; Technical Specification Group Core Network and Terminals; Evolved Packet System (EPS); Mobility Management Entity (MME) and Serving GPRS Support Node (SGSN) related interfaces based on Diameter protocol (Release 19) 3GPP TS 29.272 V19.1.0 (2025 March)
4. 3^{rd} Generation Partnership Project; Technical Specification Group Core Network and Terminals; 5G System; Public Land Mobile Network (PLMN) Interconnection; Stage 3 (Release 19) 3GPP TS 29.573 V19.2.0 (2025 March)
5. 3^{rd} Generation Partnership Project; Technical Specification Group Core Network and Terminals; 5G System; Unified Data Repository Services; Stage 3 (Release 19) 3GPP TS 29.504 V19.2.0 (2025 March)
6. 3^{rd} Generation Partnership Project; Technical Specification Group Core Network and Terminals; 5G System; Usage of the Unified Data Repository services for Subscription Data; Stage 3 (Release 19) 3GPP TS 29.505 V19.2.0 (2025 March)
7. 3^{rd} Generation Partnership Project; Technical Specification Group Core Network and Terminals; Cx and Dx interfaces based on the Diameter Protocol; Protocol details (Release 18) 3GPP TS 29.229 V18.1.0 (2024 September)
8. 3^{rd} Generation Partnership Project; Technical Specification Group Core Network and Terminals; 5G System; Unified Data Management Services; Stage 3 (Release 19) 3GPP TS 29.503 V19.2.0 (2025 March) 3^{rd} Generation Partnership Project; Technical Specification Group Core Network and Terminals; 5G System; Authentication Server Services; Stage 3 (Release 19) 3GPP TS 29.503 V19.2.0 (2025 March)
9. Oracle Communications Diameter Signaling Router; Diameter User Guide; Release 8.6; F54888-01 (April 2022)
10. Oracle Communications; Cloud Native Security Edge Protection Proxy (SEPP) User's Guide; Release 1.4.0; F35438-01 (September 2020)
11. Diameter Interconnect Security, Version 9.1, GSMA FS.19 (21 Apr. 2023) 12.5G Interconnect Security, Version 2.3, GSMA FS. 36 (21 Apr. 2023)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for supporting time and velocity checks for roaming subscribers crossing access networks of different types, the method comprising:
maintaining a Diameter/service-based interface (SBI) subscriber database of roaming subscriber registration information for registrations in a plurality of different access network types;
receiving, at a common point of policy enforcement for the different access network types, a signaling message relating to a roaming subscriber seeking to register or update a location of the roaming subscriber in one of the different access network types;
accessing, by the common point of policy enforcement and using information in the signaling message, the Diameter/SBI subscriber database and locating previous registration information relating to the roaming subscriber;
performing, by the common point of policy enforcement and using the previous registration information, a time and velocity check for a registration or location update requested by the signaling message; and
updating, by the common point of policy enforcement, registration information for the roaming subscriber in the Diameter/SBI subscriber database in response to determining that the registration or location update requested by the signaling message passes the time and velocity check.

2. The method of claim 1 wherein the common point of policy enforcement comprises a combined Diameter edge agent (DEA) and security edge protection proxy (SEPP) deployment.

3. The method of claim 2 wherein the combined DEA and SEPP deployment includes DEA logic for processing Diameter messages and SEPP logic for processing SBI messages.

4. The method of claim 3 wherein receiving a signaling message includes receiving, by the DEA logic, a Diameter signaling message, accessing the Diameter/SBI subscriber database includes querying, by the DEA logic, the Diameter/SBI subscriber database using information obtained from the Diameter signaling message, and performing the time and velocity check includes determining, by the DEA logic, whether it is possible to travel from a location obtained from the Diameter/SBI subscriber database and a location indicated by the Diameter signaling message within a time period equal to a difference between a current timestamp and a timestamp associated with the location obtained from the Diameter/SBI subscriber database.

5. The method of claim 4 comprising, performing, by the DEA logic, a network security action responsive to determining that the registration or location update requested by the Diameter signaling message fails the time and velocity check.

6. The method of claim 5 wherein performing the network security action includes blocking the Diameter signaling message.

7. The method of claim 3 wherein receiving a signaling message includes receiving, by the SEPP logic, an SBI signaling message, accessing the Diameter/SBI subscriber database includes querying, by the SEPP logic, the Diameter/SBI subscriber database using information obtained from the SBI signaling message, and performing the time and velocity check includes determining, by the SEPP logic, whether it is possible to travel from a location obtained from the Diameter/SBI subscriber database and a location indicated by the SBI signaling message within a time period equal to a difference between a current timestamp and a timestamp associated with the location obtained from the Diameter/SBI subscriber database.

8. The method of claim 7 comprising, performing, by the SEPP logic, a network security action responsive to determining that the registration or location update requested by the SBI signaling message fails the time and velocity check.

9. The method of claim 8 wherein performing the network security action includes blocking the SBI signaling message.

10. The method of claim 3 wherein receiving the signaling message includes receiving the signaling message at an ingress gateway, and the method further comprises:
determining, by the ingress gateway, whether the signaling message is a Diameter signaling message or an SBI signaling message;
forwarding, by the ingress gateway and responsive to determining that the signaling message is a Diameter signaling message, the Diameter signaling message to the DEA logic; and
forwarding, by the ingress gateway and responsive to determining that the signaling message is an SBI signaling message, the SBI signaling message to the SEPP logic.

11. A system for supporting time and velocity checks for roaming subscribers crossing access networks of different types, the system comprising:
at least one processor and a memory;
a Diameter/service-based interface (SBI) subscriber database for storing roaming subscriber registration information for registrations in a plurality of different access network types; and
a common point of policy enforcement for the different access network types, implemented using the at least one processor and configured to:
receive a signaling message relating to a roaming subscriber seeking to register or update a location of the roaming subscriber in one of the different access network types;
access, using information in the signaling message, the Diameter/SBI subscriber database;
locate previous registration information relating to the roaming subscriber;
perform, using the previous registration information, a time and velocity check for a registration or location update requested by the signaling message; and
update registration information for the roaming subscriber in the Diameter/SBI subscriber database in response to determining that the registration or location update requested by the signaling message passes the time and velocity check.

12. The system of claim 11 wherein the common point of policy enforcement comprises a combined Diameter edge agent (DEA) and security edge protection proxy (SEPP) deployment.

13. The system of claim 12 wherein the combined DEA and SEPP deployment includes DEA logic for processing Diameter messages and SEPP logic for processing SBI messages.

14. The system of claim 13 wherein the signaling message comprises a Diameter signaling message and the DEA logic is configured to access the Diameter/SBI subscriber database by querying the Diameter/SBI subscriber database using information obtained from the Diameter signaling message, and perform the time and velocity check by determining whether it is possible to travel from a location obtained from the Diameter/SBI subscriber database and a location indicated by the Diameter signaling message within a time period equal to a difference between a current timestamp and a timestamp associated with the location obtained from the Diameter/SBI subscriber database.

15. The system of claim 14 wherein the DEA logic is configured to perform a network security action responsive to determining that the registration or location update requested by the Diameter signaling message fails the time and velocity check.

16. The system of claim 15 wherein the network security action includes blocking the Diameter signaling message.

17. The system of claim 13 wherein the signaling message comprises an SBI signaling message and the SEPP logic is configured to access the Diameter/SBI subscriber database by querying the Diameter/SBI subscriber database using information obtained from the SBI signaling message and perform the time and velocity check by determining whether it is possible to travel from a location obtained from the Diameter/SBI subscriber database and a location indicated by the SBI signaling message within a time period equal to a difference between a current timestamp and a timestamp associated with the location obtained from the Diameter/SBI subscriber database.

18. The system of claim 17 wherein the SEPP logic is configured to perform a network security action responsive to determining that the registration or location update requested by the SBI signaling message fails the time and velocity check.

19. The system of claim 18 wherein the network security action includes blocking the SBI signaling message.

20. A non-transitory computer readable medium having stored thereon executable instructions that when executed by a processor of a computer control the computer to perform steps comprising:
maintaining a Diameter/service-based interface (SBI) subscriber database of roaming subscriber registration information for registrations in a plurality of different access network types;
receiving, at a common point of policy enforcement for the different access network types, a signaling message relating to a roaming subscriber seeking to register or update a location of the roaming subscriber in one of the different access network types;
accessing, by the common point of policy enforcement and using information in the signaling message, the Diameter/SBI subscriber database and locating previous registration information relating to the roaming subscriber;
performing, by the common point of policy enforcement and using the previous registration information, a time and velocity check for a registration or location update requested by the signaling message; and
updating, by the common point of policy enforcement, registration information for the roaming subscriber in the Diameter/SBI subscriber database in response to determining that the registration or location update requested by the signaling message passes the time and velocity check.
